(19) United States
(12) Patent Application Publication
(10) Pub. No.: US 2016/0301263 A1
(43) Pub. Date: Oct. 13, 2016

(54) METHOD FOR WIRELESS POWER TRANSMISSION

(71) Applicant: TOSHIBA ELECTRONICS EUROPE GMBH, Düsseldorf (DE)

(72) Inventor: Marcus SCHORPP, Lempäälä (FI)

(21) Appl. No.: 15/037,994

(22) PCT Filed: Nov. 21, 2014
(86) PCT No.: PCT/EP2014/075327

§ 371 Date: May 19, 2016

(30) Foreign Application Priority Data
Nov. 22, 2013 (DE) 10 2013 112 929.3
Mar. 10, 2014 (EP) 14158495.3
Mar. 12, 2014 (EP) PCT/EP2014/054774

(51) Int. Cl. H02J 50/80; H02J 50/10; H02J 50/60; H02J 7/02

(52) U.S. Cl. CPC H02J 50/80; H02J 7/025; H02J 50/10; H02J 50/60

(57) ABSTRACT

The disclosure relates to a method for wireless power transmission between a transmitter and a receiver, comprising a power phase and a measurement phase, wherein the receiver measures a received power during the measurement phase and transmits information on the measured power to the transmitter, wherein the transmitter compares the power output by said transmitter with the power measured by the receiver and from this determines a power loss, wherein the power phase is suppressed when the power loss exceeds a maximum permissible limit value, wherein, during the measurement phase, the transmitter outputs a power which is less than the power output during the power phase.

### CROSS-REFERENCE TO RELATED APPLICATIONS

This application is a National Stage of International Application No. PCT/EP2014/075327, filed on Nov. 21, 2014 and claims priority to German Patent Application No. 10 2013 112 929.3, filed on Nov. 22, 2013; European Patent Application No. 14158495.3, filed on Mar. 10, 2014; and International Application No. PCT/EP2014/054774, filed on Mar. 12, 2014. The entire disclosures of the above applications are incorporated herein by reference.

### FIELD

The disclosure relates to a method for wireless power transmission between a transmitter and a receiver, comprising a power phase and a measurement phase, wherein the receiver measures a received power during the measurement phase and transmits information on the measured power to the transmitter, wherein the transmitter compares the power output by said transmitter with the power measured by the receiver and from this determines a power loss, wherein the power phase is suppressed when the power loss exceeds a maximum permissible limit value.

### BACKGROUND

This section provides background information related to the present disclosure which is not necessarily prior art.

Methods for wireless transmission of a power are known in prior art. These methods serve for charging electronic devices such as cordless telephones for example. For this purpose, the object to be charged is placed on a charging pad, wherein the transmitter (charging pad) and the receiver (device to be charged) permanently exchange data in order to guarantee optimum power transmission. During this process, the receiver requests at regular intervals changes in the power level from the transmitter. To guarantee interoperability between charging devices and receivers from different manufacturers, a so-called “Wireless Power Standard” (WPC) has been established in prior art, wherein certain technical data such as the transmitted power for instance have been standardized. The so-called “Low Power Standard” (LP) represents such a standard. This standard transmits 5 W between transmitter and receiver in a wireless manner.

For effecting the transmission between the transmitter and the receiver only if a “valid” receiver is in fact present in the charging zone of the transmitter, prior art also provides for a so-called foreign object detection which is used for verifying that the transmitter is in fact connected with a “valid” receiver and that a metal foreign object such as a coin for instance which may be present in the charging zone by accident, is in fact not present in the transmission zone in addition to the valid receiver. Metallic foreign objects absorb electromagnetic radiation transmitted from the transmitter to the receiver. This foreign object detection thus prevents a foreign object from being heated to a high temperature by absorbed power.

### SUMMARY

This section provides a general summary of the disclosure, and is not a comprehensive disclosure of its full scope or all of its features.

The foreign object detection works in such a way that the receiver measures how much power it receives from the transmitter and sends this measured value as information to the transmitter. The transmitter in turn compares the information sent to it with the power output therefrom. In case the power loss (transmitted power minus received power) exceeds a predetermined value, it is assumed that a foreign object is present in the transmission zone of the transmitter and receives more power than allowed. In this case, the power transmission is interrupted. The threshold value predetermined for the power loss is dependent on the measuring accuracy of the measuring system that is employed and on the respective standard under which the power is transmitted from the transmitter to the receiver. In the Low Power Standard, a power of 5 W is output. At a regular measuring accuracy of approx 5%, it is possible to measure the power loss with an accuracy down to 250 mW. This power loss of 250 mW leads to a foreign object being heated to 80° for example. Such heating would still be acceptable under the aspects of safety.

However, if a higher level of power is to be transmitted between the transmitter and the receiver, considerably higher temperatures are caused with respect to a possible foreign object, at a measuring accuracy of 5%. At the transmission of a power under the so-called Medium Power Standard, which transmits an output power of 15 W, accurate measurement of the power loss is possible down to 750 mW, which however would lead to excessive heating of a foreign object.

Based on the above-described problem, it is an object of the present disclosure to provide a method for wireless power transmission between a transmitter and a receiver which enables foreign object detection in an accurately measured manner, especially in a manner independent of the use of a particular power standard, and thus prevents excessive and hazardous heating of foreign objects.

For the solution of the above-described object, the disclosure proposes a method for wireless power transmission between a transmitter and a receiver, comprising a power phase and a measurement phase, wherein the transmitter transmits a power during the measurement phase which is smaller than the power transmitted during the power phase.

According to the disclosure, the foreign object detection is thus effected at a power level which is lower compared to that of the power phase and which is sized in such a manner that the power loss does not lead to excessive heating of a possible foreign object. Accordingly, for performing the measurement phase, the power transmitted from the transmitter is reduced to an amount that guarantees safety also in case of the presence of a metallic foreign object.

The disclosure further comprises features that can be used individually or in combination with the above-described subject matter.

According to one feature of the disclosure, a calibration of the measuring system is carried out during the measurement phase.

The calibration is used for reducing measuring inaccuracies at measuring the power. In the application according to the disclosure in which power is transmitted wirelessly from a transmitter, for example a charging station, to a receiver, for example a mobile terminal, a calibration can particularly compensate the following aspects. In the first place, these are manufacturing tolerances of the transmitter and/or receiver, especially of the transmitter and/or receiver IC as well as associated discrete components (transistors, diodes, passive components, transmitter and receiver coils inclusive of their ferrites), which are required for the operation of the transmitter and/or receiver. Secondly, these are mechanical manufacturing tolerances of the transmitter and/or receiver (e.g. charging station, mobile phone), e.g. the positioning of the components, which are in the direct vicinity of the transmitter and receiver coils. These surrounding components can influence the electromagnetic field and thus the power loss of the transmission, which in turn influences the measuring accuracy. Namely, it can be provided that the receiver needs to report to the transmitter the overall power that is received by the mobile device. This can also comprise for example the power loss in the surrounding components. Tolerances in the positioning of the surrounding components thus affect the accuracy of the measuring results. Thirdly, these aspects can comprise manufacturing tolerances of the load of the receiver receiving power, for example physical or chemical manufacturing tolerances of a rechargeable battery. In devices adapted for wireless charging, the rechargeable battery is frequently located in the direct vicinity of the receiver coil and thus has a major influence on the power loss of the system, unless the entire battery is protected by a ferrite or a metallic shield. On the other hand, shielding the entire battery is often not feasible for mechanical or cost reasons so that the influence of the battery on the wireless power transmission system is often substantial. Rechargeable batteries (accumulators) are subject to vast manufacturing tolerances and additionally exhibit a strong aging effect. Further, also accumulators from different manufacturers are frequently used which may have greatly varying influences on the electromagnetic field. Conditional on the principle, this influence cannot be taken into consideration at the manufacture of the device chargeable in a wireless fashion. Fourthly, these aspects may be about inaccuracies in the setting of the foreign object detection during the development of the device. Fifthly, inaccuracies at the calculation of the received power in the receiver or transmitter IC are considered. Computations inside the IC may introduce additional inaccuracies into the power computation due to various factors. For example, some receiver ICs merely offer a limited discrete number of power correction values. Accordingly, the optimal power correction value can be some percent away from the pre-programmed power correction value selectable in practice, which fact can clearly deteriorate the measuring accuracy in addition to the above-mentioned tolerances.

Such sources of error can have two effects. If the receiver, due to the above-mentioned inaccuracies, reports for example a power that is higher than the actually received power, a foreign object that is additionally present can receive more power than allowed, without the transmitter being able to identify this condition. However, if the receiver due to the above-mentioned inaccuracies reports a received power which is lower than the actually received power, the transmitter possibly stops the power transmission also in a case where no foreign object is present.

The aim of the calibration proposed within the scope of the disclosure is to identify and compensate the above-mentioned inaccuracies. To this end, the receiver measures the received power in a fixedly defined state (during the measurement phase).

This state is particularly characterized in that it excludes error-prone or tolerance-prone parameters in the measuring section by a fixed definition of one or more measured variables. It can be provided for example that the input power for the receiver is kept constant at a predetermined value and is not varied for example as a function of other measured parameters. In this way, sources of errors can be excluded and the measurement of the actual parameters of the measuring section can thus be improved.

Accordingly, in the measurement phase, the receiver can use a predefined measuring load which is different from the real load during normal operation especially during the calibration. The received measuring power is then particularly supplied exclusively to the measuring load. The dimension of this measuring load should be exactly known in order to avoid that additional measuring inaccuracies are introduced. Since the real (external) load (e.g. an accumulator to be charged) would influence the measurement, the power output of the receiver IC can be deactivated during the measurement phase. This has the advantage that all the energy received by the cordless power transmitters flows into the measuring load.

In the measurement phase, particularly during the calibration, the transmitter transmits a predefined power to the receiver. The amount of this power can be stored in the receiver. From the received power, which the receiver can very precisely measure on the basis of the measuring load, the receiver can determine how much power loss must be taken into account in the later power transmission phase.

The power loss at a higher power transmission during the power phase behaves almost linearly in relation to the measured power of the measurement phase. In some cases, however, a non-linear behavior must be considered, e.g. due to saturation of the ferrite at high levels of power transmission. Conditional on the principle, this cannot be measured at a low power transmission. To determine the corresponding gradient and the offset of the power loss, it can be advantageous for the calibration being performed at different levels of power, i.e. to take power loss measurements with several different measuring power levels. The gradient of the power loss is caused by normal absorption of electromagnetic radiation. The offset can be caused by losses in the receiver IC for example which are not dependent on the intensity of the transmitted power.

According to an advantageous feature of the disclosure, a measuring load (e.g. a resistance) can be directly integrated in the receiver, especially in a receiver IC. This is advantageous particularly in a case where the transmitted power is limited during the measurement phase. Such an integrated measuring load can be set to a very precise value at the manufacture of the receiver, especially of the IC. This enables a correspondingly accurate measurement of the received power (and hence the power loss). Measuring the power loss with the use of integrated measuring loads during the transmission of high power is difficult because of the thermal load of the ICs. The total transmitted power minus the power losses would have to be dissipated through the measuring load. A measuring load outside of the IC, which could accept higher power losses, would be possible, but is not to be preferred. In this case, the measuring load would in turn be subject to uncertainties which could strongly influence the system, e.g. the above-mentioned manufacturing tolerances and also the inaccuracies at the implementation of the circuit. Further, such a measuring load for higher loads requires a large space, which is often not advantageous in the given applications. Moreover, the measurement at a high measuring load in the terminal device causes a very high thermal load, even though only for a short time during the (repeating) measurement phase. All in all, these drawbacks can be removed with the measuring load integrated in the receiver, for which reasons this embodiment is particularly advantageous.

Without the above-described calibration it has only been possible up to present to manufacture devices with a measuring accuracy in the receiver in the range of 5% at a cost level of mass production. Accordingly, with 5 W of transmitted power, a measuring inaccuracy of +/−250 mW is obtainable, which keeps the heating of a typical foreign object within tolerable limits. When the power transmission is increased to 15 W, the possible power loss in a foreign object correspondingly increases to temperatures which cannot be considered safe any longer. Namely, a measuring tolerance of 5% results in a not securely determinable power loss in the foreign object of 750 mW.

It turned out that with the above-described calibration the measuring accuracy can be improved to e.g. 2%, without considerable additional efforts and costs for the system components. At 15 W and a measuring accuracy of 2%, this corresponds to a possible power loss in the foreign object of 300 mW, which presently can still be regarded as safe. Accordingly, if the above-described calibration is used, the measuring accuracy can be considerably increased with the use of standard components as far as possible, and can even be increased to such an extent that a reliable foreign object detection is still possible at a transmission of a relatively high power of 15 W.

According to an alternative or additional feature of the disclosure, the power can be gradually changed between the measurement phase, in particular the calibration, and the power phase. This kind of change in the level of power can be initiated on part of the receiver and/or transmitter. This gradual change can take place within a defined period of time, i.e. there can be provided a maximum duration within which the change to a desired power value has to be concluded. In other words: there can be predetermined a kind of change characteristic. By the detection of a pre-known change characteristic, the transmitter and/or receiver can be prepared for a transition to take place between the measurement phase and the power phase.

For example, if the receiver detects a decreasing transmitted power despite requiring the transmitter to keep the power constant or to increase the power and if the power decreases in a previously defined time interval by a previously defined amount, the receiver has to assume that the transmitter intends to initiate a measurement phase. Accordingly, the receiver can get ready for the measurement phase because it is not suddenly deprived of its available power. The receiver frequently obtains its power necessary for operation only from the power which is transmitted wirelessly. At a sudden loss of this wirelessly transmitted power, the receiver is unable to warn for instance the device which is supplied with power through the receiver against the power loss.

The reduction of power should take place within a predefined time interval and should also keep a predefined value, because otherwise the receiver could misinterpret other power reductions as an initiation of the measurement phase. Such power reductions can be caused for instance by a loss of electric current of the transmitter or by removing the receiver device from the charging station.

As a change characteristic there can also be predetermined for instance a value “power change per second”, on the detection of which a measurement or power phase needs to be initiated.

According to an additional or alternative feature of the disclosure it can be provided that the measurement phases and the power phases alternate in a temporal succession. The measurement phase is repeated at a particular time interval between successive power phases in order to thus guarantee a high degree of safety at regular intervals.

Alternatively, it can also be provided that a one-time measurement phase is performed in a temporal succession prior to a power phase. The measurement phase serves as an initial process ahead of a long continuous power phase. This variant of the embodiment is based on the assumption that it is relatively unlikely under certain structural conditions of the transmitter and the receiver that a foreign object comes between the transmitter and the receiver during the charging process and may thus be heated. Applied to the transmission of an output power of 15 W (Medium Power Standard), the power loss can be measured for example within a 5 W measurement phase (Low Power Standard) and the calculated power loss can be memorized so that the same serves as a calibration for guaranteeing the measuring accuracy also at 15 W. Such switching from a 15 W power phase to a 5 W measurement phase and vice versa is possible because both standards are compatible with each other and especially have a same transmission frequency. In case no foreign object is detected during the measurement phase, i.e. the power loss is below the maximum allowable limit value, the power phase is switched.

It is provided in particular that the transmitter outputs a power of more than 5 W, particularly 15 W, during a power phase. With such a configuration, it is possible to benefit from the disclosure in a particularly advantageous way. Power phases with an output power of more than 5 W, particularly 15 W, are unsuitable for taking a safe measurement of the power loss. If the measurement was taken at the output power of the power phase (e.g. 15 W), the resulting power loss would be 250 mW at a measuring accuracy of 5% and the resulting foreign object temperatures would accordingly be higher than 80° C. for example. This can lead to dangerous burns or even to fire. Insofar the disclosure is useful and advantageous wherever more than 5 W are transmitted during the power phase.

It is particularly advisable that the transmitter transmits a power of 5 W at maximum during a measurement phase. But also a power clearly lower than 5 W can be transmitted. Thus the power transmitted during the measurement phase is preferably lower than the power of more than 5 W, particularly 15 W in the Medium Power Standard, transmitted during the power phase. Accordingly, this configuration advantageously results in a power phase with high power and in a measurement phase with low power so that a high power can be transmitted during the power phase on the one hand and on the other hand the foreign object detection can be performed without the risk of fire or injury during the measurement phase.

According to a first embodiment of the disclosure, the transmitter initiates a measurement phase. In this case, the transmitter transmits on its own initiative an output power of 5 W for instance. The repetition frequency of the measurements during the measurement phases advantageously corresponds to the repetition frequency of the measurements during the power phase known in prior art. In the present Medium Power Standard, the repetition frequency of the foreign object measurement typically is 1.5 s and 4 s at maximum. This means that the time difference between two successive measurements amounts to 1.5 s and to 4 s at maximum. In this manner, there is simultaneously defined the time interval within which the receiver needs to report the information on the received power to the transmitter. Accordingly, the period between two reports shall typically be 1.5 s, but can also be 4 s at maximum. The receiver identifies the measurement phase by the reduction of the power to 5 W and thereupon measures the power received during this measurement phase and transmits information on that back to the transmitter. After the receiver has received the information, it increases the transmitted power to the power of the power phase, i.e. to more than 5 W, particularly 15 W, if the measured power loss between the transmitted power and the received power does not exceed a predetermined limit value. For this transmitter-initiated change of the power level there is merely required a receiver of a simple structure.

Alternatively, it can be provided that the receiver initiates a measurement phase. In this variant of the embodiment, the receiver prompts the transmitter to reduce the transmitted power, for example to 5 W. In this case, too the repetition frequency of the measurements during the measurement phase advantageously corresponds to the repetition frequency of the measurements during the power phases known in prior art, wherein the repetition frequency changes more or less, because according to this variant the receiver may determine when it takes the measurement as long as it remains within the maximum allowable time period between two measurements (4 s). Advantageously, this “request” of the receiver is made using a particular data format “foreign object detection”, which can accelerate the process compared to a common misperformance data packet. After power reduction, the receiver measures the power received within the measurement phase and reports this information to the transmitter. The transmitter receives this information and compares the power transmitted therefrom with the power received by the receiver. Depending on the power loss that is determined in this way, the power transmission is either continued or not, i.e. in case the power loss is below the predetermined limit value, the receiver can again request an output power which is higher than the measurement power. It is advantageous that the receiver itself can spontaneously determine the point of time best suited for initiating the measurement phase. It is possible in particular that the receiver chooses a point of time for the initiation at which small differences in power exist for both the transmitter and the receiver itself between the power phase and the measurement phase. The receiver may particularly choose the best point of time in dependence of the present charging current. Moreover, as the power transmitted from the transmitter is requested by the receiver, it is possible for the receiver to initiate a gradual reduction of the transmitted power so that between the power of the power phase and the power of the measurement phase there is not a gradual change in the power but rather a continuous loss of power. Thus the occurrence of electromagnetic interfering fields within the integrated circuits of both the receiver and the transmitter is prevented.

### DRAWINGS

The drawings described herein are for illustrative purposes only of selected embodiments and not all possible implementations, and are not intended to limit the scope of the present disclosure.

In the following the disclosure will be described in more detail by way of examples.

It is shown by:

FIG. 1

a) a transmitter with a receiver placed thereon,

b) a transmitter with a foreign object placed thereon,

c) a transmitter with a receiver and a foreign object placed thereon;

FIG. 2 power characteristics of the transmitter and receiver during a transmitter-initiated process;

FIG. 3 power characteristics of the transmitter and receiver during a receiver-initiated process;

FIG. 4 a block diagram of a possible power flow between the transmitter and the receiver.

### DETAILED DESCRIPTION

Example embodiments will now be described more fully with reference to the accompanying drawings.

FIG. 1a) to c) illustrate the different situations the transmitter 1 can be in.

According to a), a receiver 2, for example a cordless telephone, is in communication with the transmitter 1. Prior to transmitting power, the receiver 2 identifies itself to the transmitter 1. In this phase, the transmitter 1 preferably is in the measurement phase 5 so that it outputs only a low power. For the purpose of measurement, the transmitter 1 receives from receiver 2 a response signal including information on the power the receiver 2 has received from the transmitter 1. Now the transmitter calculates a power loss as a difference from the power transmitted therefrom and the power transmitted back from the receiver 2. In case the amount of this power loss is below a maximum limit value, the transmitter 1 identifies the receiver 2 as a “valid object” and switches from the measurement phase 5 (e.g. 5 W) to the power phase (e.g. 15 W). Thereafter the receiver 2 is charged with 15 W power.

According to b), there is only a foreign object 3 placed on the transmitter 1. This foreign object 3 can be a coin for example. On the basis of changes in the electromagnetic field, the transmitter 1 recognizes that a field-absorbing object 3 is placed on the transmitter. As a consequence, the transmitter 1 increases the output power for a short time, with the aid of which the receiver 1 typically identifies itself to the transmitter 1 via feedback. As the foreign object 3 does, however, not possess such feedback capabilities, the transmitter 1 again cuts off the output power as a result of the lacking feedback.

In c), a situation is shown in which both a receiver 2 and a foreign object 3 are in contact with the transmitter 1. In this situation, the transmitter 1 receives from the receiver 2 information on the power which the receiver 2 receives from the transmitter 1. Due to the foreign object 3, which is additionally placed on the transmitter 1, the receiver 2 receives a lower power from the transmitter 1 than this would be the case without a foreign object 3. The transmitter 1 then compares the power transmitted therefrom to the power received by the receiver 2 and calculates the difference, i.e. the power loss. In case this power loss exceeds a predetermined limit value, the power phase is not initiated, i.e. the transmitter 1 remains in the measurement phase 5 until the foreign object 3 is removed. As the power loss can be determined only with an accuracy that is dependent on the measuring method, a “dark zone” is produced in which the presence of the foreign object 3 cannot be detected and the latter is therefore heated. Accordingly, the threshold for the power loss is predetermined by the measuring accuracy of the measuring system.

FIG. 2 shows an example in which switching between the power phase 4 and the measurement phase 6 is initiated by the transmitter 1. The example is directed to a variant of the embodiment in which the method according to the disclosure is carried out with the power phases 4 and the measurement phases 5 alternating. Based on a power phase 4, in which the transmitter 1 transmits 15 W power, the transmitter 1 switches the transmitted power from 15 W to 5 W after a predetermined time period. The transmission of a power of 5 W here corresponds to the measurement phase. As can be seen in the Figure, this results in a gradual decrease from 15 W to 5 W. The output power respectively stated corresponds to the power of the Medium Power Standard and the Low Power Standard, although the disclosure can be implemented also with other power values. In the WPC MP Standard (Medium Power Standard), the period between the individual transmissions typically corresponds to 1.5 s and to 4 s at maximum. During the measurement phase 5, the receiver 2 measures the power received from the transmitter 1 and correspondingly informs the transmitter 1 on the power it has received. In the present example, the received power amounts to 4 W. Then the transmitter 1 calculates the difference between the power (5 W) transmitted therefrom and the power (4 W) received by the receiver 2. In case the difference (0.2 W), i.e. the power loss, is below a predetermined limit value, it will be inferred that no foreign object 3 is present on the transmitter (this is assumed in the present case). Then the transmitter 1 again switches the power transmitted therefrom from 5 W to 15 W. With this action, a next power phase 4 begins. The switching between the power phase 4 and the measurement phase 5 can take place at a predetermined interval. But alternatively it would also be possible for this switching to take place at irregular intervals, for example based on an instruction transmitted from the receiver 2, wherein the instruction is transmitted at a moment which is deemed suitable by the receiver 2.

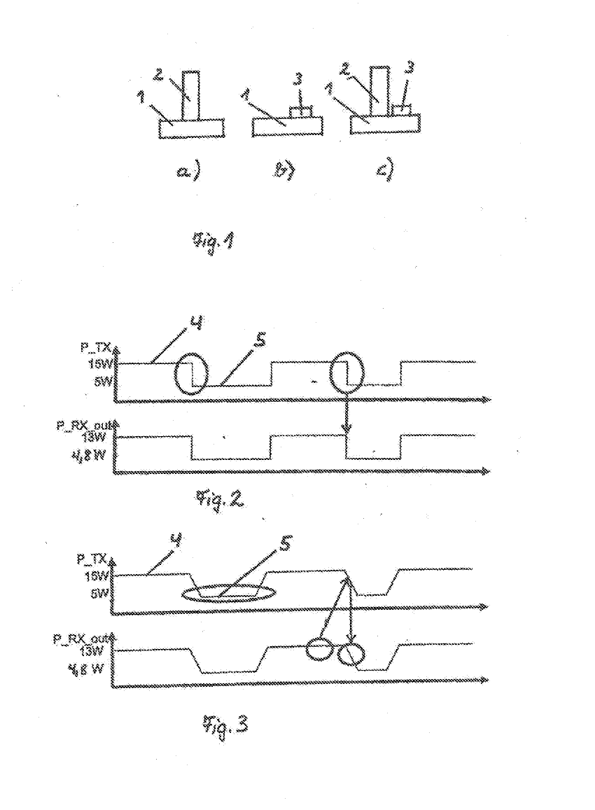

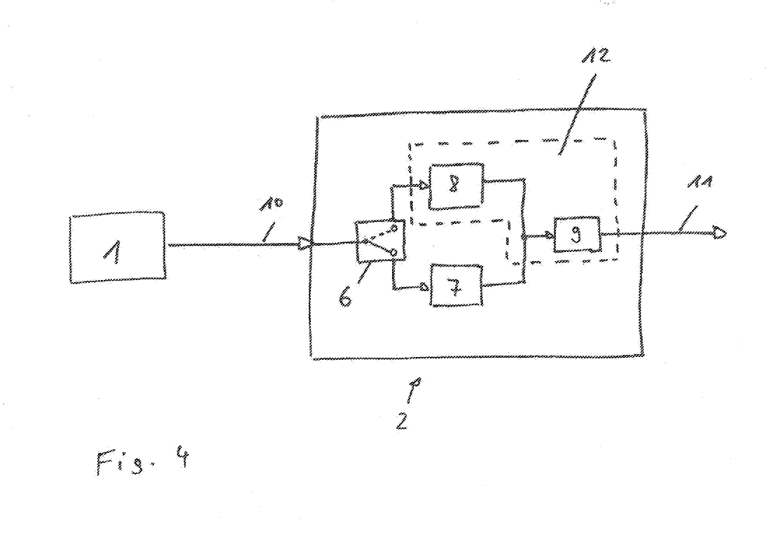

FIG. 3 shows a method in which the change in power level is initiated by the receiver 2. At a point of time that can be freely determined by the transmitter 1, the transmitter 1 is prompted by the receiver 2 to reduce the transmitted power so that a measurement phase 5 can be performed with lower output power. As shown in FIG. 1, the receiver 2 can gradually request the transmitter 1 to continuously reduce the transmitted power until the power has decreased from 15 W to 5 W. The receiver 2 can determine the best point of time for switching the transmitted power in accordance with its present charging and load current situation. In case the receiver 2 only receives 13 W out of 15 W, as in the given example, the same can prompt an immediate measurement phase 5 in which it is verified if a foreign object 3 is present between the transmitter 1 and the receiver 2. During the measurement phase 5, the receiver 2 measures the power received from the transmitter 1 and informs the transmitter 1 about its measuring result. After the transmitter 1 has received this information from the receiver 2, it calculates the power loss and prevents switching to the power phase 4 until the foreign object 3 is removed if the presence of a foreign object is assumed. On the other hand, if the power loss is below the respective predetermined limit value, the transmitter 1 switches the power from the measurement power, e.g. 5 W, back to the power for the power phase 4, e.g. 15 W, on request from the receiver 2.

FIG. 4 shows an embodiment of a possible power flow between the transmitter 1 and the receiver 2. The transmitter 1 emits a power that is supplied as input power 10 to the receiver 2. In the receiver 2, there is shown in an exemplary manner a real load 7 on the one side and a measuring device on the other side. The real load 7 represents the transmission distance in the receiver 2 minus the measuring device 9. The real load 7 particularly comprises the battery to be charged (e.g. of a smartphone). Moreover it also includes an error such as manufacturing tolerances of the battery and/or the receiver, particularly of a receiver IC, mechanical manufacturing tolerances of the battery and/or the receiver, errors at the setting of the foreign object detection, computation-related inaccuracies caused by an analog-to-digital conversion or the like.

During normal operation, the measuring device 9 measures this real load 7 and hence all related errors and tolerances. For the purpose of calibration it is now provided that there can be switched between the real load 7 and a measuring load 8 within the receiver 2. A switch 6 serves this purpose. The switch 6 can be part of an integrated circuit and/or can receive signals for switching from a corresponding control unit.

Depending on the switching position of the switch 6, the input power 10 is either exclusively applied to the real load 7 or to the measuring load 8. Both loads are connected with the measuring device 9. Therefore the measuring device 9 can measure both the power applied to the real load 7 and to the measuring load 8.

The measuring load 8 has the advantage already described above that the load, for example a resistance, can be very precisely determined. This means that there is available in the measuring device 9 very precise information on the power that should be measured at the measuring load 8. Accordingly, the quality of the above-described errors can be precisely inferred from a possibly measured deviation.

The measuring device 9 outputs a measuring power 11. This can be transmitted to the transmitter 1 so that the same can make a comparison between the input power 10 transmitted therefrom to the receiver 2 on the one side and a measured measuring power 11 on the other side.

According to an advantageous further development, the measuring load 8 together with the measuring device 9 can be integrated in an IC. Thus the measurement can be rendered even more precisely so that errors can be identified still more precisely.

The above-described calibration has the advantage that the errors in the receiver 2, which respectively lead to shares in power loss, can be detected very precisely. In this manner, the accuracy of the measuring system can be clearly increased without the need of using expensive components. In this manner it is even possible to implement a wireless power transmission of medium-scale power such as 15 W, while foreign objects can be detected with the required accuracy (approx 250 mW) as before.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for wireless transmission of a power between a transmitter and a receiver, comprising a power phase and a measurement phase, wherein the receiver measures a received power during the measurement phase by means of a measuring device and transmits information on the measured power to the transmitter, wherein the transmitter compares the power transmitted therefrom with the power measured by the receiver and identifies a power loss therefrom, wherein the power phase is suppressed when the power loss exceeds a maximum allowable limit value, wherein the transmitter outputs a power during the measurement phase which is lower than the power output during the power phase, wherein a calibration of the measuring device is performed during the measurement phase.

2. The method according to claim 1, wherein for the purpose of calibration switching between a real load and a measuring load is performed in the receiver.

3. The method according to claim 2, wherein for the purpose of calibration switching to a measuring load integrated in the measuring device of the receiver is performed.

4. The method according to claim 1, wherein during calibration there is transmitted from the transmitter to the receiver a power which is predefined and stored in the measuring device.

5. The method according to claim 1, wherein during calibration there are transmitted from the transmitter to the receiver at least two power levels different from each other in magnitude.

6. The method according to claim 1, wherein the power transmitted from the transmitter to the receiver during the measurement phase, in particular during calibration, is limited to a maximum value.

7. The method according to claim 1, wherein the measurement phases and power phases alternate in a succession of time.

8. The method according to claim 1, wherein the measurement phases, especially also the calibration, are performed at regular time intervals.

9. The method according to claim 1, wherein prior to a power phase, a one-time measurement phase and/or calibration is performed.

10. The method according to claim 1, wherein during a power phase, the transmitter outputs a power of more than 5 W, particularly 15 W.

11. The method according to claim 1, wherein during a measurement phase, the transmitter outputs a power of 5 W at maximum.

12. The method according to claim 1, wherein the transmitter initiates a measurement phase.

13. The method according to claim 1, wherein the receiver initiates a measurement phase.

14. The method according to claim 1, wherein the power is gradually changed at a transition between the power phase and the measurement phase.

15. The method according to claim 14, wherein the gradual change of the power is performed at a predefined time interval.
